(19) United States
(12) Patent Application Publication
(10) Pub. No.: US 2009/0148786 A1
(43) Pub. Date: Jun. 11, 2009

(54) Regulated Cooling for Chemically Prepared Toner Manufacture

(76) Inventors: Danielle Renee Ashley, Longmont, CO (US); James Robert Combes, Boulder, CO (US); Donna Marie Erk, Louisville, CO (US); Lale Gokbudak Lovell, Longmont, CO (US); James Michael Piffarerio, Erie, CO (US); William Albert Spalding, Longmont, CO (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/952,355

(22) Filed: Dec. 7, 2007

(51) Int. Cl. G03G 9/12

(52) U.S. Cl. 430/137.14

(57) ABSTRACT

The present disclosure relates generally to chemically prepared toner (CPT) that employs a regulated cooling process subsequent to coalescence and fusing. The cooling process may influence the distribution of domain morphology of the components within a toner particle such as controlling release agent domain formation and accompanying migration to the toner particle surface.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to chemically prepared toner (CPT) that employs a regulated cooling process subsequent to coalescence and fusing. The cooling process may influence the distribution of domain morphology of the components within a toner particle such as controlling release agent domain formation and accompanying migration to the toner particle surface.

2. Description of the Related Art

Image forming devices, such as printers or copiers, may utilize toner to form images on various forms of media. Toner may include resin, a wax, colorant and, optionally, additives. Toner may be produced via a number of processes. Some processes are mechanical, wherein the toner components are blended, formed into strands or pellets and then ground to a desired particle size. Other processes are chemical, wherein the toner particles are grown during polymerization and/or emulsion aggregation processes to form desired particle sizes.

### SUMMARY OF THE INVENTION

In a first exemplary embodiment, the present disclosure is directed at a process for producing a toner particulate composition. The process includes forming an aqueous dispersion comprising polymer binder having a glass transition temperature (Tg), including a release agent and a stabilizing agent and flocculating into an aggregated mixture of particles. This may be followed by heating below the polymer binder Tg and forming aggregates of 2-25 microns and then heating at a temperature above the Tg of the polymer binder and fusing together the polymer binder and release agent and forming fused particles of polymer binder and release agent wherein the particles have an outer surface. This may then be followed by cooling at a rate sufficient to reduce migration of release agent to the outer particle surface.

Another exemplary embodiment relates to a process for producing a toner particulate composition. The process includes forming an aqueous dispersion comprising polymer binder having a glass transition temperature (Tg), including a release agent and a stabilizing agent and flocculating into an aggregated mixture of particles. This may then be followed by heating below the polymer binder Tg and forming aggregates of 2-25 microns and then heating at a temperature above the Tg of the polymer binder and fusing together the polymer binder and release agent and forming fused particles of polymer binder and release agent and cooling at a rate of 2° C./min to 15° C./min.

A still further exemplary embodiment relates to a process for producing a toner particulate composition. The process includes forming an aqueous dispersion comprising polymer binder having a glass transition temperature (Tg), including a release agent and a stabilizing agent and adjusting pH and flocculating into an aggregated mixture of particles. This may then be followed by heating below the polymer binder Tg and forming aggregates of 2-25 microns and adjusting pH to ionize the stabilizing agent and heating at a temperature above the Tg of the polymer binder and fusing together the polymer binder and release agent and forming fused particles of polymer binder and release agent and cooling at a rate of 2° C./min to 15° C./min.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a flow-chart illustrating one general example of the present disclosure as applied to a CPT toner manufacturing process;

FIG. 2 is an electron micrograph of toner particles without the use of a regulated cooling process during chemically processed toner manufacture;

FIG. 3 is an electron micrograph of toner particles that employs a regulated cooling process as disclosed herein during chemically processed toner manufacture;

FIG. 4 is a plot of developer roll filming (banding versus time) for CPT toner particles employing a temperature regulated cooling process as compared to CPT toner particles without regulated cooling; and

FIG. 5 is a plot of doctor blade streaks versus time for CPT toner particles employing a temperature regulated cooling process as compared to CPT toner particles without regulated cooling.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

As noted above, toner may be utilized in image forming devices to form images on media, such as paper, transparencies, etc. Devices that use toner may include printers, copiers, fax machines, etc. Generally, toner may include a binder, wax, colorants and, optionally, additives. The binder may be a polymeric type resin, which may provide appropriate fusing characteristics when used in an electrophotographic type printer. Exemplary binders may include thermoplastic type polymers such as styrene or styrene acrylate type polymers, polyester polymers, etc. Colorants may be used herein to describe compositions that may impart color or other visual effects to toner. Colorants may include pigments, dyes or a combination thereof. The toner composition so formed may then be positioned within a toner cartridge for an image forming device such as a laser printer.

The toner compositions herein may be produced by chemical processes, wherein the toner particles may be grown in an aqueous solution to obtain a desired particle size. Such growth may occur due to the process of flocculation, which may be understood herein as the process by which destabilized particles conglomerate into relatively larger aggregates.

Accordingly, a general description of a chemical process for forming toner may start with the formation of an aqueous dispersion that contains a polymer binder having a glass transition temperature (Tg) and a release agent in the presence of a stabilizing agent. Such dispersion may then be flocculated into an aggregated mixture of particles. This may then be followed by heating below the Tg of the polymer binder and forming aggregates of 2-25 microns. Such aggregates may then be heated to a temperature above the Tg of the polymer binder with fusing the polymer binder and release agent to form fused particles of polymer binder and release agent, where the particles have an outer surface. This may then be followed by cooling, as described more fully below, which has been found to influence the migration of release agent to the particle surface.

A more specific example of a chemical process for producing toner may therefore again begin by dispersing in aqueous media, the individual constituents of the toner composition, i.e., the resin/polymer binder, release agent (wax), colorant (pigment particles), and/or charge transfer additive. Each constituent may be dispersed separately in its own aqueous environment or in one aqueous mixture as may be desired. One may then introduce stabilizing agents containing, e.g., anionic functional groups (A−), e.g. anionic surfactants and/or anionic polymeric dispersants. One may also use stabilizing agents containing cationic functional groups (C+), e.g. cationic surfactants and/or cationic polymeric dispersants. Whether prepared individually and combined, or in one aqueous medium, the constituents may then be mixed and homogenized to provide a dispersion for the preparation of toner particles. In addition, a surfactant or dispersant may be understood herein as a chemical agent that can lower the interfacial tension of a given organic and/or hydrophobic compound in an aqueous environment or assemble into aggregates (e.g. micelles).

Expanding upon the above, in the chemical manufacture of toner according to the present disclosure, polymer latexes may be prepared from the polymerization of vinyl type monomers such as styrene and acrylic in the presence of anionic type surfactants. Pigments may be milled in water along with a surfactant that has the same functionality (and ionic charge) as the surfactant employed in the polymer latex. Release agents such as a wax (polyolefin and/or carnauba type) may also be prepared using a surfactant that has the same functionality (and ionic charge) as the surfactant employed in the polymer latex. Reference to polyolefin type wax herein may be understood as a hydrocarbon polymer that may include linear or branched polyalkylenes such as polyethylenes, polypropylenes, ethylene-propylene copolymers and mixtures thereof. Accordingly, such polymer may include saturated hydrocarbons of the formula CₙH₂ₙ₊₂ and/or unsaturated hydrocarbons having the formula CₙH₂ₙ. Such polymers may therefore have the following repeating unit structure —(CₙH₂ₙ₊₂)ₘ— wherein m is an integer that provides a number average molecular weight (Mn) of less than or equal to 7,500. Typically, the Mn values may be between 500-5000, including all values and increments therein. The waxes may also include synthetic waxes such as a synthetic polyolefin wax. Typically, the melting point (Tm) of the polymeric wax may be in the range of 60° C. to 135° C., including all values and increments therein. For example, the Tm of the wax may be 60° C. to 85° C. The wax may be present in the toner particles in an amount by weight ranging from 1-15% based on the total weight of the toner particles.

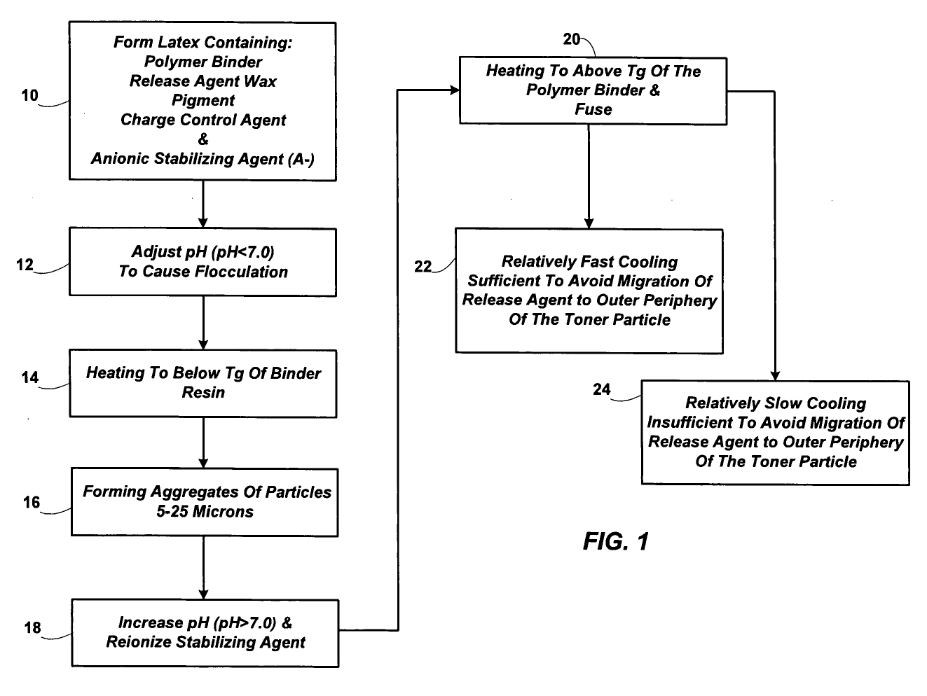

A charge control additive (CCA) may then be included. FIG. 1 now conveniently illustrates one form of CPT preparation that relies upon the initial use of an anionic stabilizing agent. As shown, the polymer latex, pigment latex, wax latex and CCA may be mixed and stirred 10 to ensure a homogenous dispersion. Acid may then be added at 12 to reduce the pH and cause flocculation. Flocculation is reference to formation of what may be described as a “gel” where resin, pigment, wax and CCA may form an aggregated mixture of particles 1-2 μm in size. The flocculated mixture may then be heated at 14 resulting in a viscosity drop. Such heating may be below the (Tg) of the polymeric binder resin. The gel may then collapse and loose (larger) aggregates, e.g., of from 2-25 μm size may be formed at 16 from the 1-2 μm particles. Base may then be added at 18 to increase the pH and reionize the surfactant/stabilizing agent or one may add additional anionic type surfactants. The temperature of the mixture may then be raised to a temperature above the Tg of the polymer binder, for example, at least about 10° C. to 70° C. above the Tg of the polymer binder, to bring about coalescence/fusing of the particles. Accordingly, coalescence is reference to fusion of all the components into toner particles.

Other exemplary methods of forming toner by chemical techniques may be found in U.S. Pat. Nos. 6,531,254; 6,531,256 and 6,991,884 whose teachings are incorporated herein by reference.

The present disclosure proceeds with the feature of a regulated or what may be understood as a relatively fast cooling process or protocol 22. Such protocol may be set at a rate that is sufficient to control and/or avoid migration of the release agent to the outer peripheral surface of the particle. This stands by contrast to a relatively slow cooling rate 24, which would otherwise be insufficient to control and/or avoid migration of the release agent to the outer periphery of the toner particle. Accordingly, it is contemplated herein that for a given polymer binder/release agent formulation, one may reduce the migration of release agent from the particle surface by selection of the relatively fast cooling protocol disclosed herein. More specifically, for a given toner/release agent formulation, one may reduce the visual amount of release agent that may appear in scanning electron microscopy (SEM) at a magnification of 5000× to a value of less than or equal to about 5.0% of the toner particle surface under view.

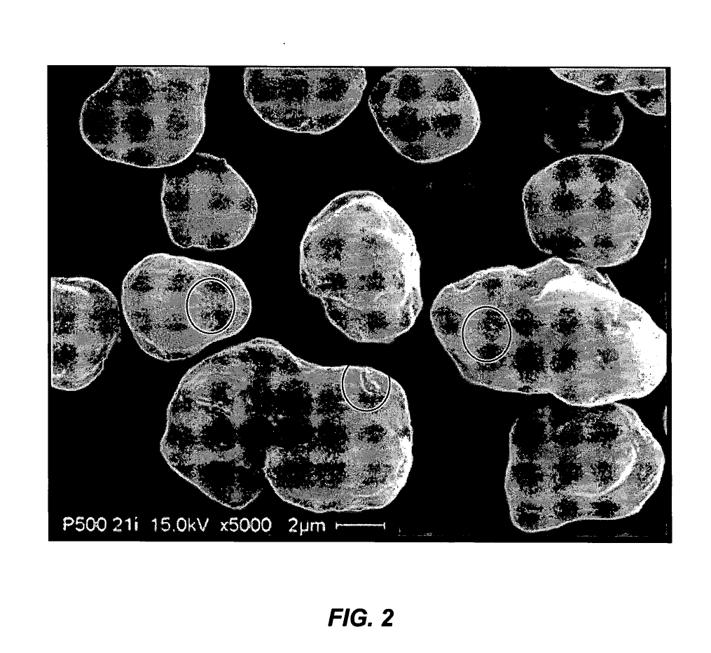

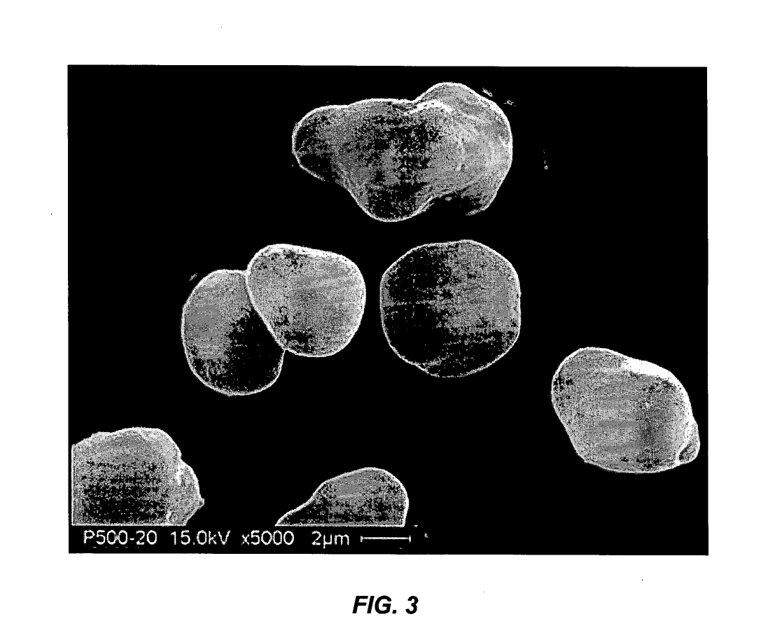

Attention is therefore first directed to FIG. 2, which is an electron micrograph of black toner particles made by a CPT process utilizing a relatively slow cooling rate after coalescence and fusing, as described above. This particular toner was sourced from the release agent FTX-1 wax (Michelman), wherein the wax was present at a level of 6.0% by weight, along with 8% by weight carbon black and 3.75% of charge transfer agent, BONTRON E88. As can be seen from the circled regions, surface wax domains can be observed on the surface of the toner particles. FIG. 3 represents a toner particle prepared herein utilizing a relatively fast cooling rate, as noted above. Once again, this particular toner was sourced from the release agent FTX-1 wax (Michelman), wherein the wax was present at a level of 6.0% by weight, along with 8% by weight carbon black and 3.75% of charge transfer agent, BONTRON E88. As can be observed, there is a general absence of wax domains on the surface of the toner particles. Accordingly, as noted above, the present disclosure contemplates that on average, for a given toner formulation, 5.0% or less of the particle surface area under view indicates the presence of release agent material.

The relatively fast cooling rate herein may be more particularly understood as a cooling rate of greater than or equal to 2° C./min. For example, the cooling rate may be from 2° C./min to 15° C./min, including all values and increments therein. This may be achieved, e.g., by introducing cooling water into the process after coalescence and fusing, which cooled water may serve to provide such desired cooling rates throughout a given volume of fused toner particles that may be present. The water temperature may therefore be at a temperature below the Tg of any of the binder resins that may be present. The water temperature may also be more specifically at a temperature of 1-40° C., which will generally present a relatively cool medium as compared to temperature of the now coalesced toner particles.

It has been found herein that by utilizing the above referenced cooling protocol, the relative amount of filming that occurs may be reduced. That is, by utilizing relatively fast cooling of the coalesced or fused toner particles, it has been observed that there is a reduction in the relative amount of filming, which may be understood as the adhesion of the toner to surfaces in the electrophotographic printer that are undesirable. As may be appreciated, filming on a given surface in an electrophotographic printer, such as on a developer roller and/or doctor blade, may generate streaks or other defects in the printed media.

Accordingly, once the toners are isolated, extra particulate additives may then be blended with the unfinished toner powder and the finished toner samples are run through a filming test. The filming test fixture consists of a metal framework that allows the insertion of a developer unit (a toner storage area, a developer roller, a toner adder roller and a doctor blade) in a manner and orientation that simulates the actual mounting within a printer. The fixture also includes a drive motor and gear train, which are designed to couple with the developer unit, once it is inserted into the fixture. The motor may be controlled at a constant speed, which may duplicate the rotational speed of the developer unit in a printer. The fixture also includes three independently adjustable high voltage power supplies. Each power supply may provide the bias voltage to one of the three main components of the developer unit. Those three bias voltages are the developer roll bias, the toner adder roll bias, and the doctor (metering) blade bias.

A filming test may then be used to assess the ability of a toner to resist filming onto the doctor blade and/or the developer roll. It is to be noted that the nature of the test utilized herein may be relatively more stressful to the toner than in actual use in a given printer. This is because there is no movement of toner out of the developer unit during such testing, as the testing procedure herein does not include a photoconductor drum in contact with the developer roller by which a toned latent image can be created. As a consequence, the relatively small quantity of toner in the toner storage area associated with the developer unit is relatively stagnant and is mechanically worked in a relatively severe manner for a number of hours. This is known to increase the relative tendency of the toner to deposit or film onto surfaces. Nevertheless, it is still a useful tool for doing comparisons of toners to gage their tendencies to film.

Filming resistance may be measured in hours to onset of filming. Each toner under test is placed in the toner storage area and run on the filming test fixture, with stops every hour to inspect the cartridge for evidence of filming. Print samples are made each hour with the test cartridge, and the prints are also inspected for evidence of filming. The developer unit and print samples are compared against a sample set that was previously associated with different observed and relative levels of filming, as described below.

Developer roll filming may be assessed by examining the developer roller and comparing the level of filming against a reference set labeled 0 to 4 where 0 is no film and 4 is a relatively severe film on the developer roller. In particular, developer roller filming is assessed by evaluating the presence of film bands on the developer roller, which may be understood as filming down the horizontal axis of the roller surface. Doctor blade filming is assessed by examining the amount of vertical streaks present on a printed page and comparing it against a reference print sample set in which 0 is no streaking and 10 is severe streaking. When a pre-defined level of filming of the doctor blade is observed, the test is stopped and the total elapsed time (in hours) to reach that filming level is recorded.

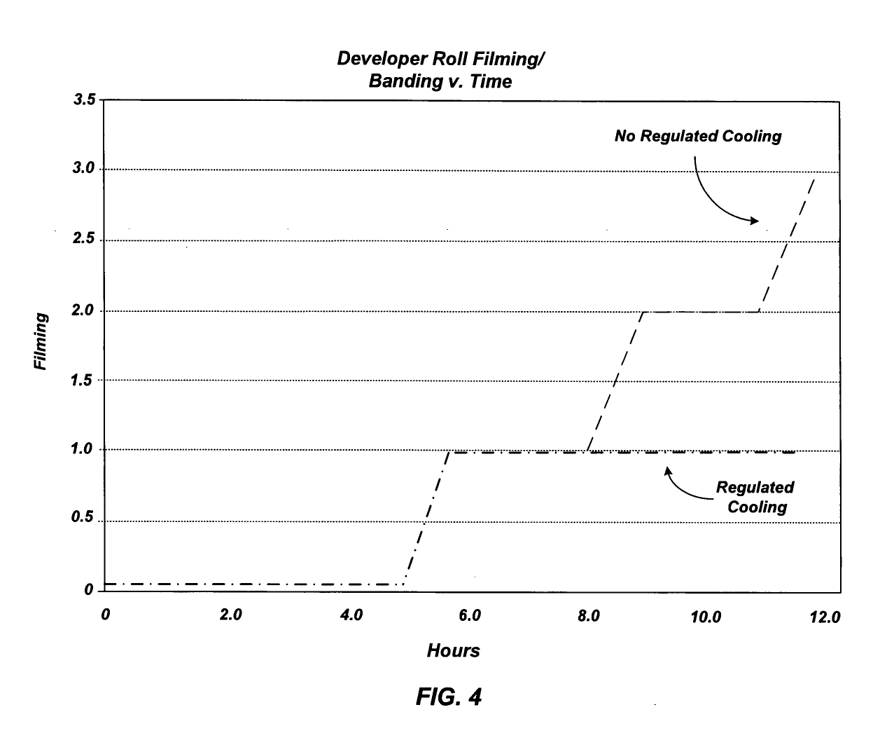

Attention is next directed to FIG. 4 which specifically provides an evaluation of developer roll filming in an electrophotographic printer, utilizing the two toner samples identified above printing at 29 pages per minute (ppm). As can be seen, toner prepared without regulated cooling indicated relatively higher amounts of filming (banding) after about 8.0 hours of testing, reaching a peak relative value of about 3.0 after 12.0 hours of testing. By contrast, toner prepared with the regulated cooling protocol described herein shows relatively lower levels of filming (a value of about 1.0) after 12.0 hours of testing.

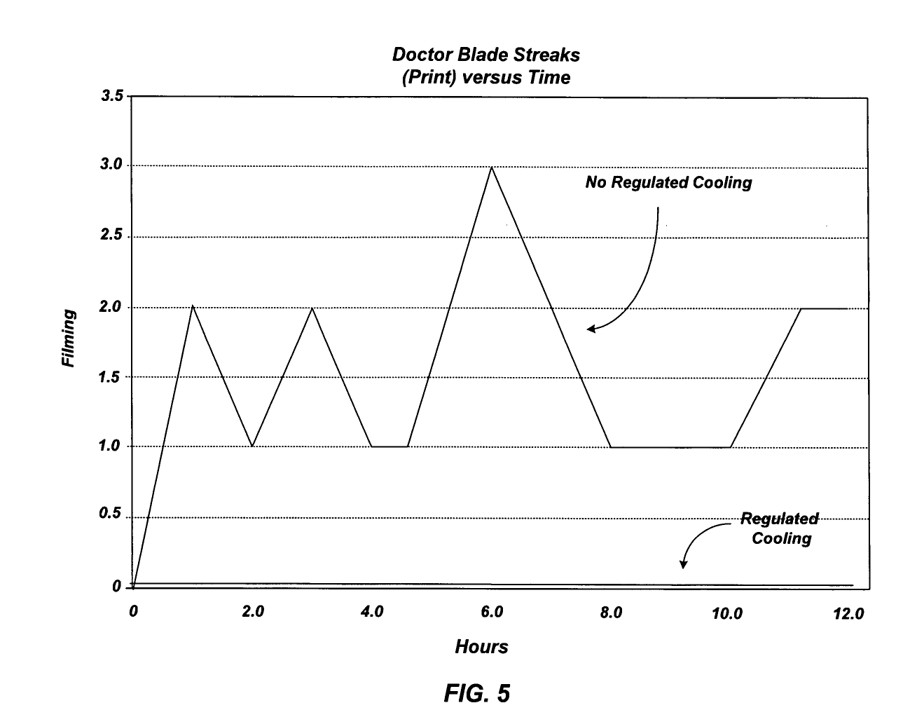

Attention is next directed to FIG. 5 which specifically provides an evaluation of doctor blade streaks (print) versus time, again, at the print speed of 29 ppm. As can be seen, toner prepared without regulated cooling indicated varying and higher amounts of relative filming peaking to levels as high as about 3.0 after 6.0 hours along with a value of about 2.0 after about 12.0 hours. By contrast, toner prepared with the regulated cooling protocol described herein indicated effectively a zero value of doctor blade filming after 12.0 hours of testing.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A process for producing a toner particulate composition comprising:
(a) forming an aqueous dispersion comprising polymer binder having a glass transition temperature (Tg), including a release agent and a stabilizing agent and flocculating into an aggregated mixture of particles;
(b) heating below the polymer binder Tg and forming aggregates of 2-25 microns;
(c) heating at a temperature above the Tg of the polymer binder and fusing together the polymer binder and release agent and forming fused particles of polymer binder and release agent wherein said particles have an outer surface; and
(d) cooling at a rate sufficient to reduce migration of release agent to said outer particle surface.

2. The process of claim 1 wherein 5.0% or less of the particle surface area viewed by scanning electron microscopy indicates the presence of release agent material.

3. The process of claim 1 including adjusting the pH of said dispersion and flocculating into an aggregated mixture of particles.

4. The process of claim 1 including adjusting the pH prior to heating and fusing said polymer binder and release agent, wherein said pH adjustment ionizes said stabilizing agent.

5. The process of claim 1 wherein said cooling rate is 2° C./min to 15° C./min.

6. The process of claim 1 wherein said cooling comprises the addition of water to said fused binder and release agent wherein said water is at a temperature of 1° C. to 40° C.

7. The process of claim 1 wherein said release agent comprises a polyolefin including hydrocarbons of the formula —(CₙH₂ₙ₊₂)ₘ— wherein m is an integer that provides a number average molecular weight (Mn) of less than or equal to 7,500.

8. The process of claim 1 wherein said release agent has a melting point of 60° C. to 135° C.

9. The process of claim 1 wherein said release agent is present in said particles at 1-15% by weight.

10. The process of claim 1 wherein said particles are positioned within a toner cartridge for an image forming apparatus.

11. A process for producing a toner particulate composition comprising:
(a) forming an aqueous dispersion comprising polymer binder having a glass transition temperature (Tg), including a release agent and a stabilizing agent and flocculating into an aggregated mixture of particles;
(b) heating below the polymer binder Tg and forming aggregates of 2-25 microns;
(c) heating at a temperature above the Tg of the polymer binder and fusing together the polymer binder and release agent and forming fused particles of polymer binder and release agent; and
(d) cooling at a rate of 2° C./min to 15° C./min.

12. The process of claim 11 including adjusting the pH of said dispersion and flocculating into an aggregated mixture of particles.

13. The process of claim 11 including adjusting the pH prior to heating and fusing said polymer binder and release agent, wherein said pH adjustment ionizes said stabilizing agent.

14. The process of claim 11 wherein said cooling comprises the addition of water to said fused binder and release agent wherein said water is at a temperature of 1° C. to 40° C.

15. The process of claim 11 wherein said release agent comprises a polyolefin including hydrocarbons of the formula —(CₙH₂ₙ₊₂)ₘ— wherein m is an integer that provides a number average molecular weight (Mn) of less than or equal to 7,500.

16. The process of claim 1 wherein said release agent has a melting point of 60° C. to 135° C.

17. The process of claim 11 wherein said release agent is present in said particles at 1-15% by weight.

18. The process of claim 11 wherein said particles are positioned within a toner cartridge for an image forming apparatus.

19. A process for producing a toner particulate composition comprising:
(a) forming an aqueous dispersion comprising polymer binder having a glass transition temperature (Tg), a release agent and a stabilizing agent and adjusting pH and flocculating into an aggregated mixture of particles;
(b) heating below the polymer binder Tg and forming aggregates of 2-25 microns and adjusting pH to ionize said stabilizing agent;
(c) heating at a temperature above the Tg of the polymer binder and fusing together the polymer binder and release agent and forming fused particles of polymer binder and release agent; and
(d) cooling at a rate of 2° C./min to 15° C./min.

20. The process of claim 19 wherein said particles are positioned within a toner cartridge for an image forming apparatus.
